(19) United States
(12) Patent Application Publication
(10) Pub. No.: US 2025/0187563 A1
(43) Pub. Date: Jun. 12, 2025

(54) CLIMATE-BASED WINDSHIELD WIPER CONTROL

(71) Applicant: FCA US LLC, Auburn Hills, MI (US)

(72) Inventor: Pavan Lakshmipathi, Rochester Hills, MI (US)

(21) Appl. No.: 18/532,156

(22) Filed: Dec. 7, 2023

(51) Int. Cl. B60S 1/08

(52) U.S. Cl. CPC B60S 1/0866; B60S 1/0896

(57) ABSTRACT

Disclosed is a wiper blade control system for a vehicle comprising: a wiper blade electronic control unit, a temperature sensor, at least one of a windshield monitoring camera, a windshield precipitation monitor, or combinations thereof, and a wiper blade elevation motor. The wiper blade electronic control unit is connected to the temperature sensor to the at least one of the windshield monitoring camera or the windshield precipitation monitor, to the wiper blade elevation motor, and to a vehicle transmission electronic control unit. Provided the vehicle is in park, the system raises a set of wiper blades off the windshield if the external temperature either exceeds a high temperature threshold or is below a low temperature threshold. The system also raises the wiper blades if snow or ice are detected on the windshield. The system lowers the wiper blades when the conditions are no longer met.

### FIELD

The present disclosure relates to a system and method for monitoring external climate conditions and either raising the wipers off of the windshield or maintaining them on the windshield based on the external climate conditions.

### BACKGROUND

Modern vehicles often include systems for detecting precipitation on a windshield and then activating the windshield wipers based on the detected precipitation. These systems are only active when the vehicle is turned on. A significant issue for consumers in locations that have snow fall is that following snow fall the wiper blades need to be lifted off the windshield to fully clear the snow off the windshield. These locations also often experience freezing rain or other precipitation including snow that can lead to a buildup of ice on the windshield. This can cause the windshield wiper blades to stick to the windshield and to prevent the consumer from being able to raise the wiper blades off the windshield to scrape the ice off the windshield. Newer wiper blades often include softer rubber compositions and the cold temperatures can lead to premature wearing of the wiper blades. Consumers located in regions that experience very hot temperatures can also have issues with the hot weather causing warping, cracking and damage to wiper blades leading to premature aging.

### SUMMARY

The present disclosure is directed to a system and method for monitoring the external climate conditions of a vehicle when the vehicle is in park and either raising the wiper blades off of the windshield or maintaining them on the windshield based on the external climate conditions. Once the vehicle transmission is moved out of park the system is disengaged and the wiper blades are moved onto or maintained on the windshield irrespective of the external climatic conditions of the vehicle.

In at least some implementations, the wiper blade control system for a vehicle comprises a wiper blade; a control unit; a temperature sensor; and a wiper blade elevation actuator coupled to the wiper blade and operable to move the wiper blade onto and off a vehicle windshield, wherein the control unit is connected to the temperature sensor and to the wiper blade elevation actuator.

In some implementations, the temperature sensor provides an indication of an external temperature to the control unit.

In some implementations, the wiper blade control system includes at least one windshield monitoring camera and at least one windshield precipitation monitor both of which provide an output to the control unit.

In at least some implementations, the wiper blade control system further comprises a vehicle infotainment system connected to the control unit. In some implementations the wiper blade control system further comprises a user interface connected to the control unit.

In some implementations the temperature sensor provides an indication of an internal temperature to the control unit.

In some implementations, the wiper blade is part of a set of wiper blades that are connected to the wiper blade elevation actuator and the wiper blade elevation actuator is configured to raise the set of wiper blades off a windshield in response to a first signal from the control unit and to lower the wiper blades from a raised position onto the windshield in response to a second signal from the control unit.

In some implementations, a method for controlling a position of wiper blades of a vehicle relative to a windshield of the vehicle comprises the steps of: a. determining a weather condition for an area including a vehicle; b. determining if the vehicle is in a park mode; and c. causing an actuator to move a pair of wiper blades of the vehicle away from a windshield of the vehicle when the weather condition satisfies one or more wiper blade criteria.

In some implementations, the weather condition is an external temperature in the area of the vehicle, and the one or more wiper blade criteria includes a high temperature threshold, and wherein the causing step is performed when the external temperature is greater than the high temperature threshold. In some implementations, the external temperature is one or both of a current external temperature and a forecasted external temperature.

In some implementations, the weather condition is an external temperature in the area of the vehicle, and the one or more wiper blade criteria includes a low temperature threshold, and wherein the causing step is performed when the external temperature is lower than the low temperature threshold. In some implementations, the external temperature is one or both of a current external temperature and a forecasted external temperature.

In some implementations, the one or more wiper blade criteria includes presence of snow or ice on the windshield.

In some implementations, the one or more wiper blade criteria includes a forecast indicating snow or ice are likely to be on the windshield.

In some implementations, the method also includes moving the wiper blades into contact with the windshield when the vehicle is no longer in park mode.

In some implementations, the method includes obtaining the forecast at a determined periodicity. In some implementations, the method includes a step wherein the external temperature is determined periodically when the vehicle is off.

In some implementations, the method also includes moving the wiper blades into contact with the windshield when the weather condition no longer satisfies one or more wiper blade criteria.

In at least some implementations, the system comprises a wiper blade control system for a vehicle comprising: a wiper blade electronic control unit; a temperature sensor; at least one of a windshield monitoring camera, a windshield precipitation monitor, or combinations thereof; a wiper blade elevation motor; and wherein the wiper blade electronic control unit is connected to the temperature sensor; to the at least one of the windshield monitoring camera, the windshield precipitation monitor, or the combinations thereof; to the wiper blade elevation motor; and to a vehicle transmission electronic control unit.

In at least some implementations, the method is a method for controlling a position of a set of wiper blades of a vehicle relative to a windshield of the vehicle comprising the steps of: a. providing a wiper blade electronic control unit, a temperature sensor, a wiper blade elevation motor connected to said set of wiper blades, and a vehicle transmission electronic control unit; b, wherein the wiper blade electronic control unit is connected to the temperature sensor, to the wiper blade elevation motor, and to the vehicle transmission electronic control unit; c. the wiper blade electronic control unit querying the temperature sensor for an external temperature and comparing it to a predetermined high temperature threshold; d, wherein if the external temperature is above the predetermined high temperature threshold, the wiper blade electronic control unit sends a first signal to the wiper blade elevation motor and the wiper blade elevation motor raises the set of wiper blades off of the windshield of the vehicle; and e, wherein after the wiper blade elevation motor has raised the set of wiper blades, the wipe blade electronic control unit periodically queries the temperature sensor for an external temperature and compares it to the predetermined high temperature threshold and if the external temperature is below the predetermined high temperature threshold, the wiper blade electronic control unit sends a second signal to the wiper blade elevation motor and the wiper blade elevation motor lowers the set of wiper blades onto the windshield of said vehicle.

In at least some implementations the method comprises a method for controlling a position of a set of wiper blades of a vehicle relative to a windshield of the vehicle comprising the steps of: a. providing a wiper blade electronic control unit, a temperature sensor, a wiper blade elevation motor connected to said set of wiper blades, and a vehicle transmission electronic control unit; b, wherein the wiper blade electronic control unit is connected to the temperature sensor, to the wiper blade elevation motor, and to the vehicle transmission electronic control unit; c. the wiper blade electronic control unit querying the temperature sensor for an external temperature and comparing it to a predetermined low temperature threshold; d, wherein if the external temperature is below the predetermined low temperature threshold, the wiper blade electronic control unit sends a first signal to the wiper blade elevation motor and the wiper blade elevation motor raises the set of wiper blades off of the windshield of the vehicle; and e, wherein after the wiper blade elevation motor has raised the set of wiper blades, the wipe blade electronic control unit periodically queries the temperature sensor for an external temperature and compares it to the predetermined low temperature threshold and if the external temperature is above the predetermined low temperature threshold, the wiper blade electronic control unit sends a second signal to the wiper blade elevation motor and the wiper blade elevation motor lowers the set of wiper blades onto the windshield of the vehicle.

In at least some implementations the above method further comprises in step a. providing at least one of a windshield monitoring camera, a windshield precipitation sensor, or combinations thereof; wherein in step b. the wiper blade electronic control unit is connected to the at least one of the windshield monitoring camera, the windshield precipitation sensor, or combinations thereof; wherein in step d. if the external temperature is not below said predetermined low temperature threshold the wiper blade electronic control unit queries the at least one of the windshield monitoring camera, the windshield precipitation sensor, or combinations thereof and determines if there is snow or ice detected on the windshield; wherein if there is snow or ice detected on the windshield then the wiper blade electronic control unit sends the first signal to the wiper blade elevation motor and the wiper blade elevation motor raises the set of wiper blades off of the windshield of the vehicle; wherein after the wiper blade elevation motor has raised the set of wiper blades, the wipe blade electronic control unit periodically queries the at least one of the windshield monitoring camera, the windshield precipitation sensor, or combinations thereof and determines if there is snow or ice detected on the windshield; and wherein if the at least one of the windshield monitoring camera, the windshield precipitation sensor, or combinations thereof determines that there is not snow or ice detected on the windshield then the wiper blade electronic control unit sends the second signal to the wiper blade elevation motor and the wiper blade elevation motor lowers the set of wiper blades onto the windshield of the vehicle.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a schematic diagram of the components of a wiper blade control system;

FIG. 2A is a flow chart of a portion of the wiper control system logic;

FIG. 2B is a flow chart of another portion of the wiper control system logic;

FIG. 3A shows a set of wiper blades lowered onto a clear windshield; and

FIG. 3B shows a set of wiper blades raised off a windshield covered in snow.

### DETAILED DESCRIPTION

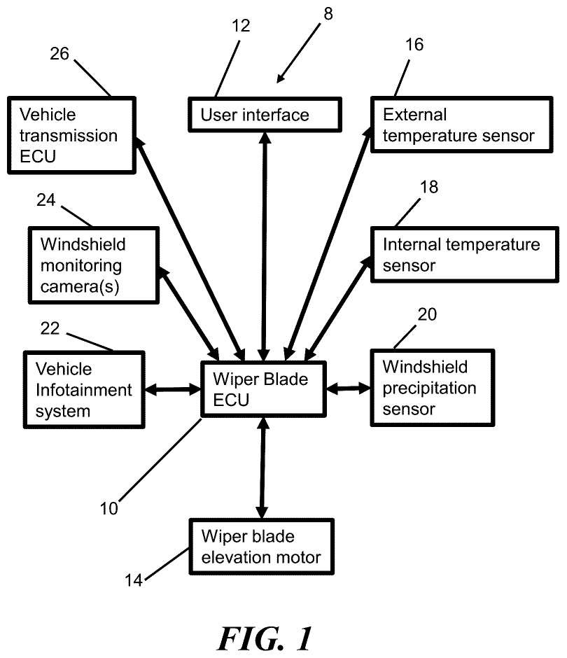

Referring in more detail to the drawings, FIG. 1 shows a schematic diagram of the components of a vehicle wiper blade control system 8. In at least some implementations, the wiper blade control system may include an electronic control unit (called herein a wiper blade ECU) 10 is connected to a user interface 12, a wiper blade elevation actuator 14, an external temperature sensor 16, an internal temperature sensor 18, a windshield precipitation sensor 20, a vehicle infotainment system 22, one or more windshield monitoring cameras 24, and a vehicle transmission or drive mode ECU 26. The wiper blade ECU 10 can receive and process temperature inputs from the external temperature sensor 16 and the internal temperature sensor 18. In at least some implementations, the wiper blade ECU can also receive input from the vehicle infotainment system 22, in particular, weather information for the location of the vehicle and future weather predictions. The wiper blade ECU 10 also receives input from the windshield precipitation sensor(s) 20 and the windshield monitoring camera(s) 24. The windshield monitoring camera(s) 24 can be part of a standard Advanced Driver Assistance Systems (ADAS) cameras on the vehicle or these camera(s) 24 can be added specifically to monitor the windshield conditions. The wiper blade ECU 10 also receives input from the vehicle transmission or drive mode ECU 26 to, for example, determine when the vehicle is in a park gear or park mode. At any time if the vehicle is shifted from park into any other setting a signal is sent to the wiper blade ECU 10 and it checks the status of the wiper blade elevation motor 14, which includes information as to the state of the wiper blades 74 and lowers the wiper blades 74 onto the windshield 76 if necessary and then the system 8 shuts down so long as the vehicle is not in park. While described as a wiper blade ECU 10, this function may be carried out by a separate control unit and/or controller or several of the herein described functions of the system 8 can be carried out by a single controller and/or control unit.

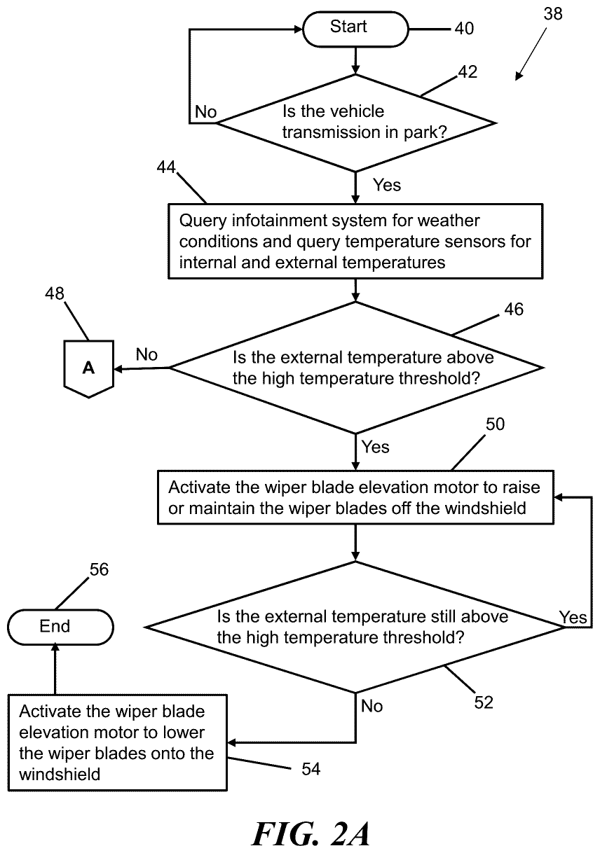

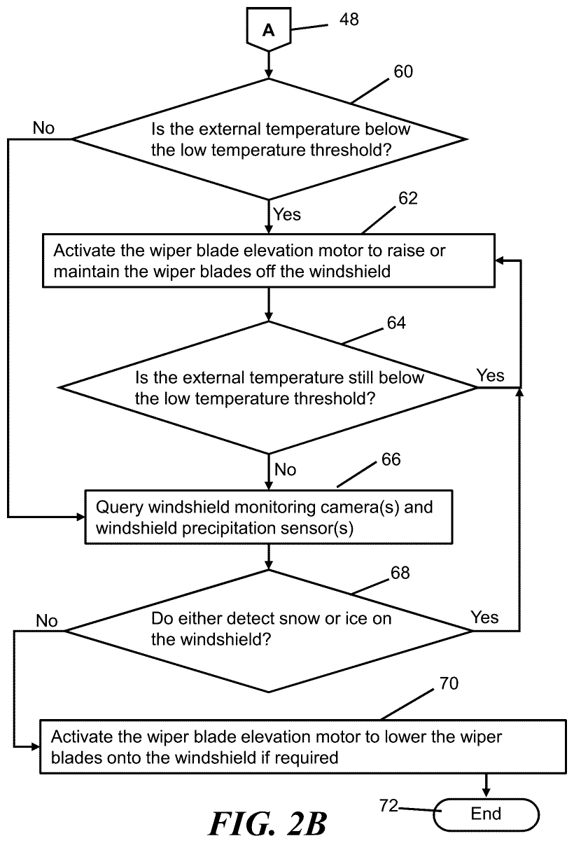

FIG. 2A is a flow chart of a portion of a wiper control method 38. The method 38 begins at start 40 and in step 42 it is determined if the vehicle is in park gear or mode, if so the method 38 proceeds to the next step 44 and if not the method returns to start 40. In step 44, data, for example from the infotainment system 22, is obtained for the current and predicted weather conditions for the current vehicle location. In addition, data is obtained from the temperature sensors 16 and 18 for the current external and internal temperatures.

In step 46, the determined external temperature is compared to a predetermined high temperature threshold to determine if the external temperature is above the high temperature threshold. If the external temperature is above the high temperature threshold then in step 50 the wiper blades 74 are moved off the windshield 76, which may be done by the wiper blade elevation actuator 14, which may include an electric motor or other rotary or linear actuator. The high temperature threshold can be set as a default setting and can also be modified by a user through the user interface 12, if desired. For example, the default high temperature threshold can be set at 90° F. (32° C.) or higher, although the high temperature can be set based upon the type of wipers used and/or as desired by a user in the user interface 12.

In step 52 the wiper blade ECU 10 will periodically query the temperature sensors 16 and 18 to determine the external temperature and compare it to the high temperature threshold. So long as the external temperature is above the high temperature threshold and the vehicle remains in park the wiper blades 74 will remain raised off the windshield 76. The periodicity of the query can be a preset period of time and can be modified by the predicted weather received from the infotainment system 22. For example, if the infotainment system 22 indicates that the weather prediction is for temperatures in excess of the high temperature threshold for the next 20 hours the wiper blade ECU 10 may increase the time between queries to reduce the total number of queries and the energy consumed by the queries within that period of time If the weather prediction is that the temperature may be changing rapidly or it predicts a lowering of the temperature, the control system may implement queries accordingly to efficiently check for temperature changes as a function of the high temperature threshold. Further, the period at which the external temperature is checked may be set as a function of the magnitude of the difference between the current external temperature and the high temperature threshold, where longer periods are used for a greater magnitude of the difference.

When it is determined in step 52 that the external temperature has gone below the high temperature threshold, then in step 54 the wiper blades 74 are moved onto the windshield 76 (e.g. via the actuator 14) and then the method proceeds to step 56 at which the method ends, or the method is looped back to an earlier step which may include the start 40 or other step, as desired. In at least some implementations, whenever it is determined that the vehicle is no longer in park, such as may be determined when the wiper blade ECU 10 receives a signal from the transmission ECU 26, then the method 38 moves to step 54 and the wiper blades 74 are moved onto the windshield 76.

The method 38 may be restarted or run again periodically, where the period may be a function of the predicted weather over a certain duration of time, for example, the next 24 hours, or it can be a predetermined period of time set by a default setting or a user determined period.

FIG. 2B is a flow chart of another portion of the wiper control method 38, specifically part (A) shown as 48 in FIGS. 2A and 2B. This part of the method 38 is performed when it is determined in step 46 that the external temperature is not above the high temperature threshold. In step 60, the determined external temperature is compared to a predetermined low temperature threshold to determine if the external temperature is below the low temperature threshold. If the external temperature is below the low temperature threshold then in step 62 the wiper blades 74 are moved off of the windshield 76.

The low temperature threshold can be set as a default setting and can also be modified by a user. In at least some implementations, the default low temperature threshold is 38° F. or lower, and may be 32° F. (0° C.), however, it can be set to any temperature desired by a user or set as a function of the atmospheric pressure which may be provided to the control system 8 by a suitable sensor. The sensor can directly measure atmospheric pressure or the pressure can be obtained from an outside source in a similar way as the weather predictions, or the pressure can be inferred from the elevation of the current vehicle location. Ice and snow may occur at different temperatures, and so higher outside temperatures may cause the system 8 to move the wiper blades off the windshield.

In step 64 the external temperature is compared to the low temperature threshold to determine if the external temperature still is below the low temperature threshold. This may be done periodically, and the period may be preset or variable and determined as a function of the weather forecast, magnitude of the difference between the current external temperature and the low temperature threshold, or otherwise. So long as the external temperature is below the low temperature threshold and the vehicle remains in park, the wiper blades 74 will remain raised off the windshield 76, in at least some implementations. For example, if the weather prediction is for temperatures below the low temperature threshold for a long duration (e.g. the next 20 hours) the wiper blade ECU 10 may increase the time between queries (e.g. to 10 hours, and perhaps increasingly shorter intervals as the time for predicted temperature rise draws nearer). If the infotainment system 22 indicates the weather may be changing rapidly or it predicts a raising of the temperature in a shorter duration of time, the external temperature queries may be done more frequently.

If the external temperature is not below the low temperature threshold when compared in step 64 or 60 the method 38 moves to step 66 to determine if snow or ice is present on the windshield. This may be done based upon information from the windshield monitoring camera(s) 24 and/or the windshield precipitation sensor(s) 20. If snow or ice is determined to be on the windshield 76 then in step 68 the wiper blades 74 are raised off the windshield 76. Steps 62, 64 and 66 may be repeated periodically, as desired so long as either the external temperature is below the low temperature threshold or snow or ice are detected or determined to be on the windshield 76, and the vehicle remains in park.

Once it is determined that the external temperature is above the low temperature threshold and there is no snow or ice detected on the windshield, the method proceeds to step 70 in which the wiper blades 74 are lowered onto/in engagement with the windshield 76. The method 38 then proceeds to step 72 and ends. As noted above, when the vehicle is no longer in park then the method may immediately move to step 70 to lower the wiper blades 74 onto the windshield 76. The method may be rerun at different intervals or periods and these may be based upon the current temperature, predicted temperature or weather, or otherwise as desired.

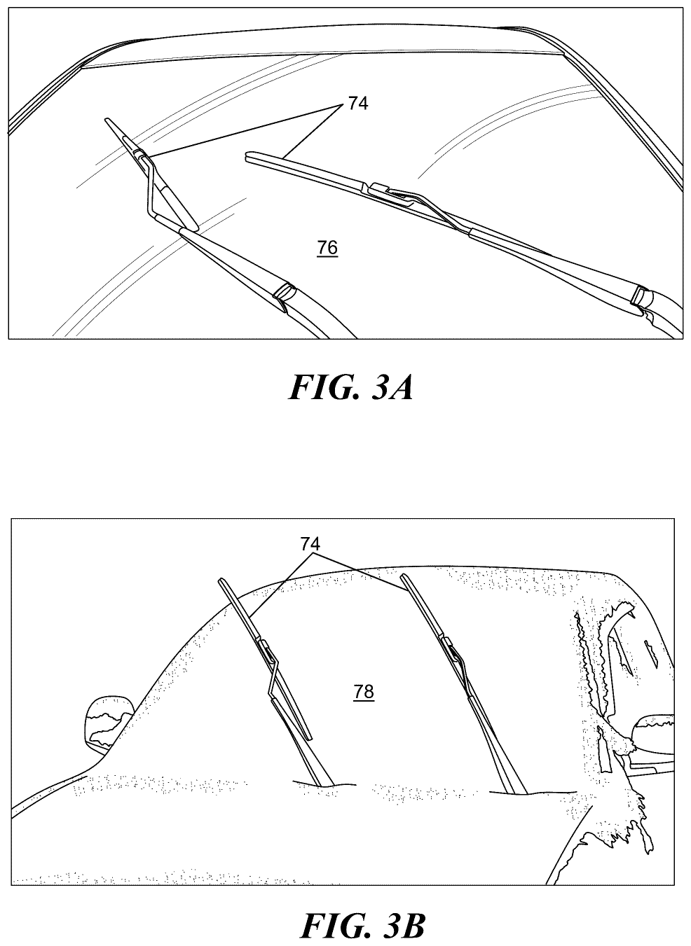

FIG. 3A shows a set of wiper blades 74 lowered onto a clear windshield 76 as would be the case after step 54 or 70 or prior to the running of the method. FIG. 3B shows a set of wiper blades 74 raised off a windshield 76 covered in snow 78 as would be the case when, for example, step 50 or 70.

With the user interface 12 or otherwise, a user could also active a winter mode or a summer mode in the wiper blade ECU 10 logic process. For example, if the winter mode was activated then the wiper blade ECU would proceed directly from steps 40 and 42, provided the vehicle is in park, to step 48 and skip steps 44 to 46 and 50 to 56 entirely. This would be convenient during the winter months when it is never expected that the external temperature will be above the high temperature threshold. Likewise, if the summer mode was activated then the logic would go from step 46 directly to step 56 when a No was returned in step 46 and never complete steps 60 to 72. Having these two modes would save time and electrical energy usage for the system 8. Alternatively, the wiper blade ECU 10 could select the summer mode or winter mode based on the time of year, location and predicted weather information that it receives from the vehicle infotainment system 22.

Further, the system may allow a user to control the high temperature threshold and the low temperature threshold. In addition, it may allow a user to turn the system 8 off and on. The user can also control the periodicity between steps 50 and 52; between steps 62 and 64; and between steps 66 and 68 to control when the queries are conducted. The user can also select the location that the vehicle infotainment system 22 uses to provide the weather information and predictions. Further, the system may permit a mode in which the wiper blades 74 are always raised off the windshield 76 when the vehicle is shifted into a park mode, or when the vehicle is turned off, and to always lower the wiper blades 74 onto the windshield 76 when the vehicle is turned on, or when the vehicle is shifted out of park mode.

In this way, the system may review one or more weather conditions against one or more wiper blade criteria. In this regard, the wiper blade criteria may include any combination of upper and lower temperature thresholds, and the presence of ice or snow, where the presence may be determined in real-time (e.g. snow or ice is actually present when this determination is made) or based upon a forecast indicating that snow or ice are likely to be on the windshield within a predetermined period. In this context, likely may mean that the forecast includes an indicated chance of precipitation and temperatures by which snow or ice may form. The indicated chance could be set at some threshold, such as 1% or greater, and in some implementations, may be set between 10% to 100% chance of precipitation in conjunction with temperatures below a threshold.

What is claimed is:

1. A wiper blade control system for a vehicle, said wiper blade control system comprising:
a wiper blade;
a control unit;
a temperature sensor; and
a wiper blade elevation actuator coupled to the wiper blade and operable to move the wiper blade onto and off a vehicle windshield, wherein the control unit is connected to the temperature sensor and to the wiper blade elevation actuator.

2. The wiper blade control system according to claim 1, wherein the temperature sensor provides an indication of an external temperature to the control unit.

3. The wiper blade control system according to claim 1, which includes at least one windshield monitoring camera and at least one windshield precipitation monitor both of which provide an output to the control unit.

4. The wiper blade control system according to claim 1, further comprising a vehicle infotainment system connected to the control unit.

5. The wiper blade control system according to claim 1, further comprising a user interface connected to the control unit.

6. The wiper blade control system according to claim 1, wherein said temperature sensor provides an indication of an internal temperature to the control unit.

7. The wiper blade control system according to claim 1, wherein the wiper blade is part of a set of wiper blades that are connected to the wiper blade elevation actuator and wherein the wiper blade elevation actuator is configured to raise the set of wiper blades off a windshield in response to a first signal from the control unit and to lower the wiper blades from a raised position onto the windshield in response to a second signal from the control unit.

8. A method for controlling a position of wiper blades of a vehicle relative to a windshield of the vehicle, comprising the steps of:
a. determining a weather condition for an area including a vehicle;
b. determining if the vehicle is in a park mode; and
C. causing an actuator to move a pair of wiper blades of the vehicle away from a windshield of the vehicle when the weather condition satisfies one or more wiper blade criteria.

9. The method of claim 8 wherein the weather condition is an external temperature in the area of the vehicle, and the one or more wiper blade criteria includes a high temperature threshold, and wherein the causing step is performed when the external temperature is greater than the high temperature threshold.

10. The method of claim 8 wherein the weather condition is an external temperature in the area of the vehicle, and the one or more wiper blade criteria includes a low temperature threshold, and wherein the causing step is performed when the external temperature is lower than the low temperature threshold.

11. The method of claim 9 wherein the external temperature is one or both of a current external temperature and a forecasted external temperature.

12. The method of claim 10 wherein the external temperature is one or both of a current external temperature and a forecasted external temperature.

13. The method of claim 8 wherein the one or more wiper blade criteria includes presence of snow or ice on the windshield.

14. The method of claim 8 wherein the one or more wiper blade criteria includes a forecast indicating snow or ice are likely to be on the windshield.

15. The method of claim 8 which also includes moving the wiper blades into contact with the windshield when the vehicle is no longer in park mode.

16. The method of claim 14 which includes obtaining the forecast at a determined periodicity.

17. The method of claim 11 wherein the external temperature is determined periodically when the vehicle is off.

18. The method of claim 12 wherein the external temperature is determined periodically when the vehicle is off.

19. The method of claim 8 which also includes moving the wiper blades into contact with the windshield when the weather condition no longer satisfies one or more wiper blade criteria.
